(19) United States
(12) Patent Application Publication
(10) Pub. No.: US 2015/0355313 A1
(43) Pub. Date: Dec. 10, 2015

(54) Hybrid Data Adaptive and Decision Adaptive Antenna Array for Automotive Radar

(71) Applicant: Toyota Motor Engineering & Manufacturing North America, Inc., Erlanger, KY (US)

(72) Inventors: Liping Li, Ann Arbor, MI (US); Paul Donald Schmalenberg, Ann Arbor, MI (US); Jae Seung Lee, Ann Arbor, MI (US)

(21) Appl. No.: 14/297,690

(22) Filed: Jun. 6, 2014

(51) Int. Cl. G01S 7/02; G01S 13/66; G01S 13/02

(52) U.S. Cl. CPC G01S 7/02; G01S 13/02; G01S 13/66

(57) ABSTRACT

A hybrid antenna apparatus for a motor vehicle includes steerable transmitter antennas and receiver antennas. The receiver antennas are arranged in sub-arrays for data adaptive and decision adaptive digital beamforming processing. A controllable phase shifter is coupled between each receiver antenna and a summation network in each receiver antenna sub-array. The plurality of sub-array summation networks are combined in mixers along with a receiver direction reference signal and output through A/D converters to the digital beamformer processor.

### BACKGROUND

The present apparatus relates to radar apparatus and, more particularly, to phase array radar.

Radar apparatus are used for various applications, such as collision avoidance in automobiles and improved vehicular cruise controls.

Decision adaptive radar describes a radar apparatus where the output of a tracking algorithm initializes the weight vector of the antenna array, such that the main formed beam can be coarsely steered toward a desired conjectured target location.

Data adaptive radar apparatus refers to radar apparatus where the structure of the data provides fine angular resolution in target angle estimation. This is also referred to as digital beam forming (DBF). Data adaptive (DBF) radars can be used in automotive radar antenna arrays to perform direction-of-arrival estimation.

Pure decision adaptive antenna array processing, although simple, easy to implement and space efficient, is poor in angular resolution because the angular resolution of an array is limited by the main beam width of the array. Full data adaptive antenna array processing has good angular resolution when performing target detection; however, the computation burden is heavy and it is complicated and expensive to implement. Typically, a DBF antenna array structure has each array element connected to an A/D converter and related circuits, which makes the whole system large and expensive in addition to the high computation burden.

It would be useful to develop an improved radar apparatus which addresses these deficiencies.

### SUMMARY

A radar apparatus for a motor vehicle includes a transmitter antenna array in the form of a planar arranged antenna array having a plurality adjacent spaced antenna elements and a receiver antenna array in the form of at least one planar antenna array of a plurality of adjacent antenna elements. The receiver array is divided into sub-arrays, each sub-array including an antenna element formed of an antenna, and a phase shifter, a summation network, and a down converting mixed coupled to an A/D converter.

The radar apparatus includes a steering control of the transmitter antenna array and the receiving antenna array to minimize side lobe clutter in the received signal.

The receiver antenna sub-array can be arranged in one of a single planar sub-array arrangement or a plurality of vertically spaced and stacked planar arrangements of sub-arrays. The plurality of spaced stacked planar receiver sub-arrays provide a vertical three dimensional envelope field of view for target detection.

The receiving antenna sub-arrays, including the summation network, the mixer and the A/D converter, use reference tracking signal coupled to the transmitter antenna array signal input to form a decision adaptive radar receiver.

In one aspect, radar apparatus is a hybrid decision adaptive and data adaptive radar apparatus. The radar apparatus includes the digital beamformer and data adaptive processing to enable the simultaneous detection and tracking of multiple targets.

The transmitter antenna array can be a single linear arranged antenna array.

The radar apparatus includes the digital beamformer utilizing prestored weights or phase shift angles to generate a reference signal for the transmitter and the receiver beam tracking in response to a detected target.

### BRIEF DESCRIPTION OF THE DRAWING

The various features, advantages and other uses of the present radar apparatus will become more apparent by referring to the following detained description and drawing in which:

FIG. 1 is a block diagram with a hybrid data and decision adaptive radar processing apparatus;

FIG. 2 is an expanded block diagram of a portion of the apparatus shown in FIG. 1;

FIGS. 3A and 3B are pictorial representations of phase shifters with different gain control;

FIG. 4 is a pictorial representation of a hybrid data and decision adaptive strategy working principle;

FIG. 5 is a graph depicting the decision adaptive steering beam and the data adaptive algorithm;

FIG. 6A is a pictorial representation of phase array radar output without using hybrid data adaptive and decision adaptive processing and showing false target images;

FIG. 6B is a pictorial representation of a hybrid data adaptive and decision adaptive phase array radar apparatus output showing only actual detected targets;

FIG. 7 is a pictorial representation of a single linear arrangement of receiver phase sub-arrays; and

FIG. 8 is a pictorial representation of a vertically stacked linear receiver phase sub-arrays.

### DETAILED DESCRIPTION

The hybrid data adaptive and decision adaptive antenna array combines decision adaptive and data adaptive antenna array processing in the small economical package with a low computation burden facilitating the issues in automotive radar apparatus.

The decision adaptive processing provides coarse steering of the transmitter array, where the transmitter array is steered by a tracking module output and precalculated phase shifter weights. The decision adaptive processing using an antenna array containing receiving sub arrays, each with phase shifters for each antenna element, and with mixers and A/D converters for each sub array creates a digital beam former. The combination of the data adaptive and decision adaptive techniques maintains the advantages of both processings; while overcoming many of the drawbacks of both processings.

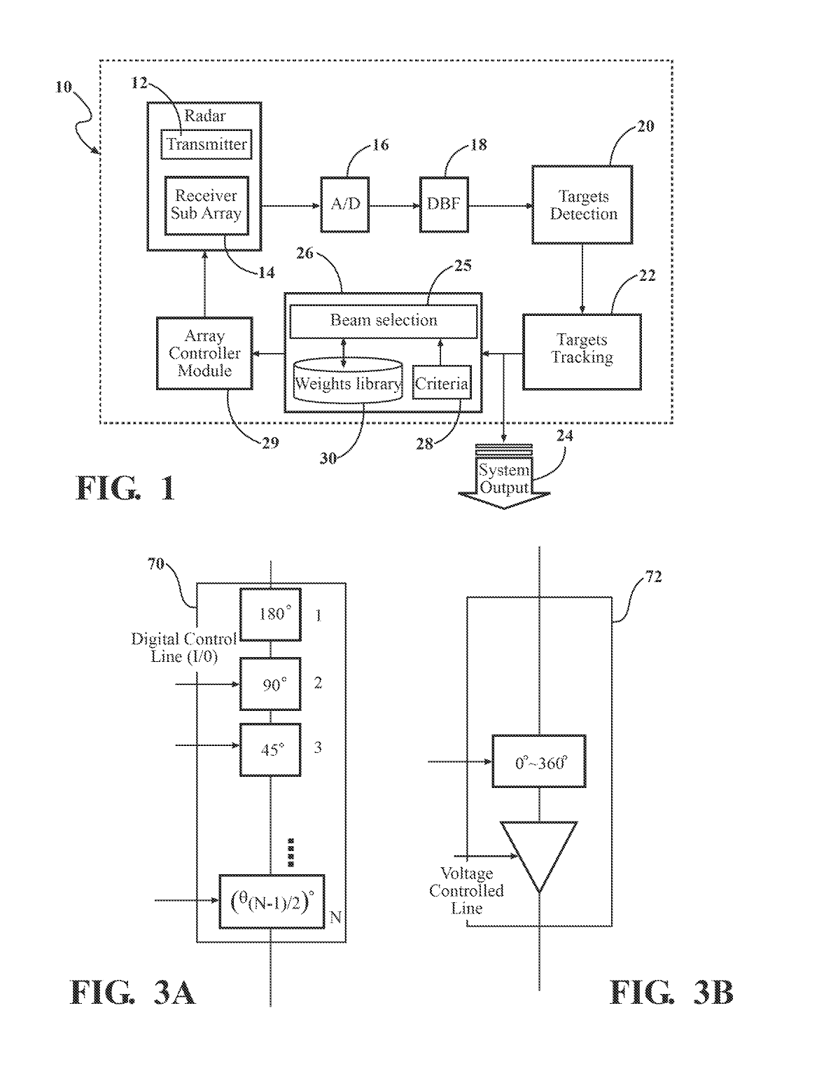

Referring now to the drawing, and to FIGS. 1, 2, 3A and 3B in particular, there is depicted a radar apparatus 10 which is a phase array radar apparatus including a transmitter array 12 and receiver array 14. A/D converters 16, a digital beamformer processor, hereafter “DBF” 18, target detection processing 20, target tracking processing 22 which feeds both a system output 24, and an array controller 26 which provides beam selection tracking control based on tracking criteria 28 and weights from a weights library 30. The output of the digital beamformer 26 feeds the array controller 28 which adjust the phase shifters 36 for each transmitter antenna 38 and the phase shifts 60 in each receiver 14 sub-array.

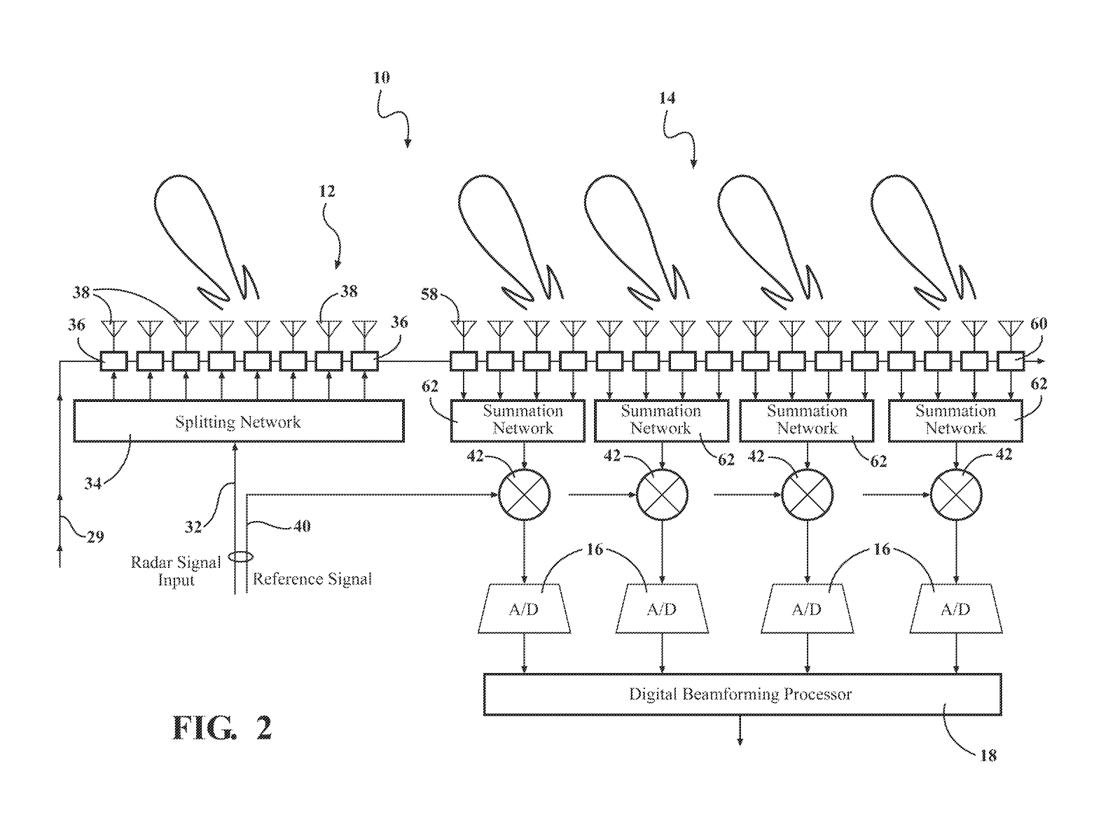

As shown in FIG. 2, the steering angle output 29 of the array controller module 28 is a signal sent to the transmitter array 12 phase shifters 36. A radar signal 32 from a PLL oscillator is supplied through the splitting network 34 of the transmitter array 12 to individual phase shifters 36 which feed the individual transmitter antennas 38.

FIG. 2 also depicts an example of an antenna array front-end structure for the receiver antenna array 14 configured for a hybrid decision adaptive, data adaptive radar apparatus. In this example, sixteen antenna elements are depicted, and for the hybrid design, the receiver array 14 is divided into four sub-arrays, with four elements in each sub-array.

A reference signal 40 coupled to the radar or signal input 32 is supplied to mixers 42, with four mixers 42 shown, by example, as being arranged in parallel. The receiver 14 sub-array receives a reflected signal from detected objects through antennas 58 which feed phase shifters 60. The output of the phase shifters 60 are grouped into the sub-arrays and supplied to individual summation networks 62 controlled by the mixers 42. The outputs of the mixers 42 are supplied through the A/D converters 16 to the digital beamformer processor 18 which outputs a signal to the target detection circuitry 20 and the target tracking circuitry 22 to yield target detection data as well as tracking information fed through the array controller 28 back to the transmitter array 12 and the receiver array 14.

FIGS. 3A and 3B illustrate different examples of phase shifter circuitry for the phase shifters 60. In FIG. 3A, each phase shifter 60 is a bit controlled phase shifter 70. The phase shifter in FIG. 3B depicts an analog voltage controlled shifter 72. Both examples of the phase shifter control make each phase shifter capable of shifting the signal phase from 0° to 360°.

In addition, the phase shifters 60 enable the steering of the receiver sub-arrays 14, and the amplitude controls can adjust the side lobes and nulls. Furthermore, the beams can be adaptively modified based on prior knowledge, such as nulling for interference or repositioning for tracking.

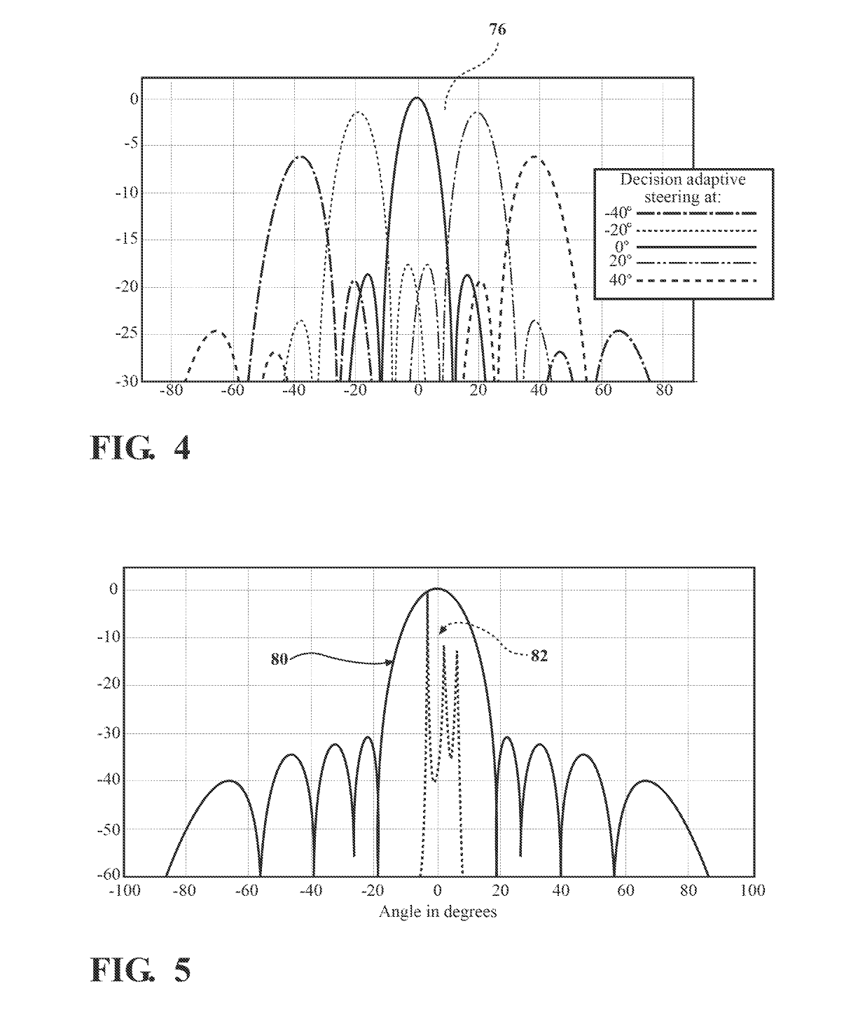

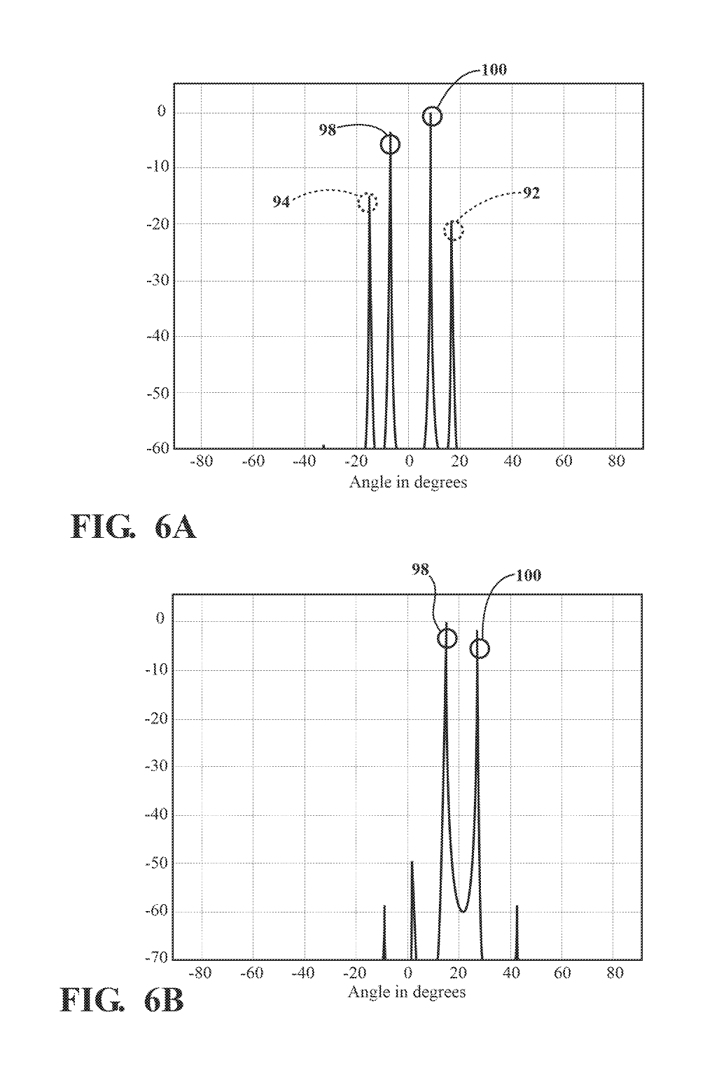

FIG. 4 depicts decision adaptive steering beams 82 in the radar apparatus 10 at different phase angles and, in FIG. 5, illustrates the formed signal 82 within each radar beam 80.

The radar apparatus 10 can detect and track multiple targets at the same time. The antenna operation is divided into separate decision adaptive and data adaptive steps. The decision adaptive step is driven by the target tracking 22 output and covers a relatively wide angle range. The specific target directions are calculated in the data adaptive section by executing digital beamforming algorithms, such as, for example, Capon's algorithm, MUSIC algorithm, etc. In FIG. 5, the decision adaptive steering beam 80 is depicted in solid line. The data adaptive beam data signal is shown by the dotted waveform 82.

The radar apparatus 10 combines decision adaptive and data adaptive antenna array processing methods to form a hybrid beam forming and processing methodology using a novel W band phase array architecture which can be used, for example, in automotive collision avoidance radar apparatus.

The decision adaptive processing sequence takes place during the detection phase of the hybrid radar system. The digital beamformer 26 accesses the pre-calculated weight library 30 and the beam selection criteria 28 to obtain target information from the target tracking module 22 and provides a course beam direction of an object interrogation.

The transmitting antenna array 12 is steered toward the same direction as the receiver array to suppress main beam side lobes.

This process is termed “decision adaptive” with the steering direction decided by the tracking module 22 output and pre-calculated weights for phase shift angles are stored in the weights library 30. This process does not require much on-time calculation and processing so it can be accomplished very efficiently and quickly.

In the radar apparatus 10 shown in FIG. 1, the elements in the transmitter array 12 and each receiver 14 sub-array are weighted with respect to both phase and amplitude, to implement coarse scanning.

FIG. 4 depicts an example of decision adapting steering at directions −40°, −20°, 0°, 20°, 40°.

The data adaptive processing utilizes digital beamforming techniques to find highly refined target angle information inside the detection area of the direction decided by the decision adaptive process as shown in FIG. 4.

In the radar apparatus 10, the outputs from the receiver 14 sub-array provide the required data sets for the digital beamformer 26. As more channels are added to the radar apparatus 10, more calculations are needed by the DBF algorithm. Furthermore, more channels are more expensive and complicated to build.

Accordingly, the hybrid radar apparatus 10 only needs access to the decision adaptive sub-array output instead of data output from each antenna element. This greatly lowers the number of channels required in the radar apparatus to minimize building cost and computation burden; while maintaining a high resolution rate comparable to full digital beam forming.

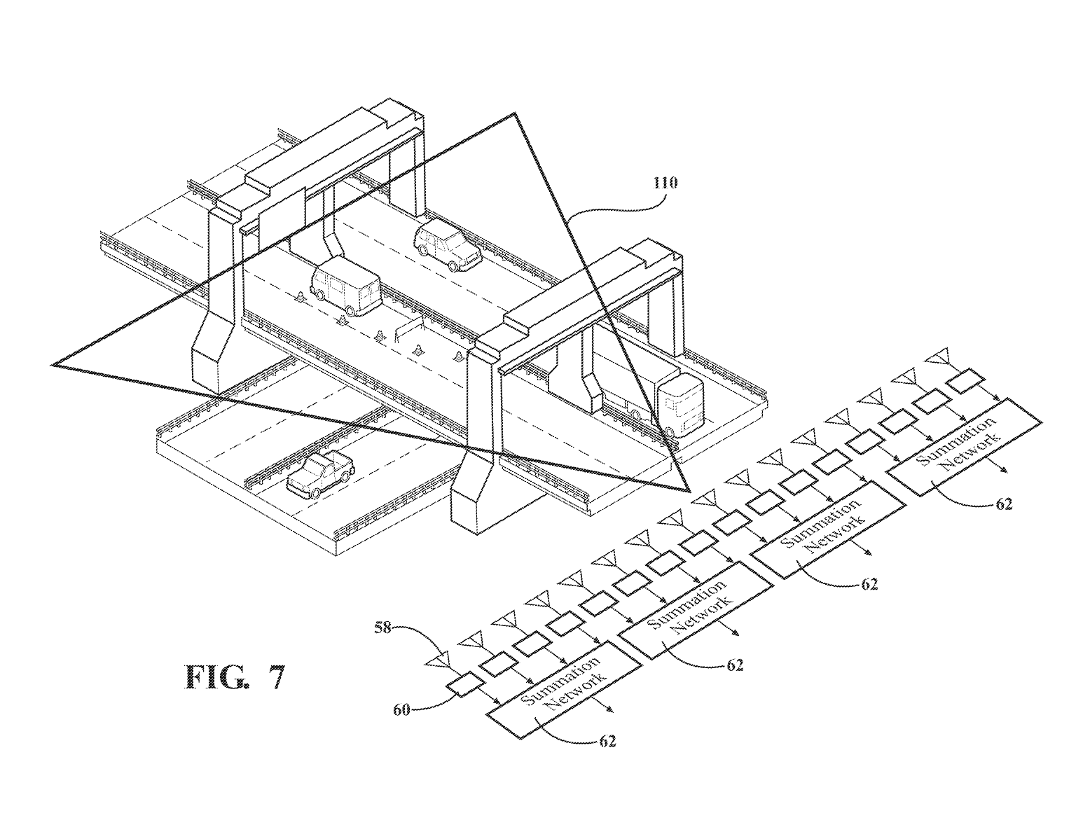

In this hybrid radar apparatus 10, grating lobes can occur inside the receiver sub-array main beam to the distance between adjacent sub-arrays, and/or the spacing between individual elements in each sub-array is greater than 0.5 λ (the distance that eliminates all grating lobes). This problem can be effectively alleviated through the transmitter antenna array 12 by applying control to the transmitter array 12, as shown in FIG. 7B so that the influence of grating lobes is reduced. The hybrid data adaptive and decision adaptive radar apparatus 10 partially suppresses the grating lobes by referencing the beam-tracking signal supplied to the transmitter array 12 with reference input signal 40 supplied to the mixers 42 of the receiver sub-arrays 14.

FIG. 6A depicts object detection without applying angle control to the transmitter array 12. False targets 92 and 94 could be detected along with real targets or objects 98 and 100.

In FIG. 6B, after steering angle control is supplied to the transmitter array 12, only real targets 98 and 100 are detected.

FIG. 7 depicts an example of a single linear arrangement of the plurality of receiver sub-array elements 58, 60, and 62. Each sub-array antenna 58 is positioned to receive an object detection beam in a field of view 110 in a single plane. The single plane or field of view 110 makes it difficult to determine the height of a detected object or target.

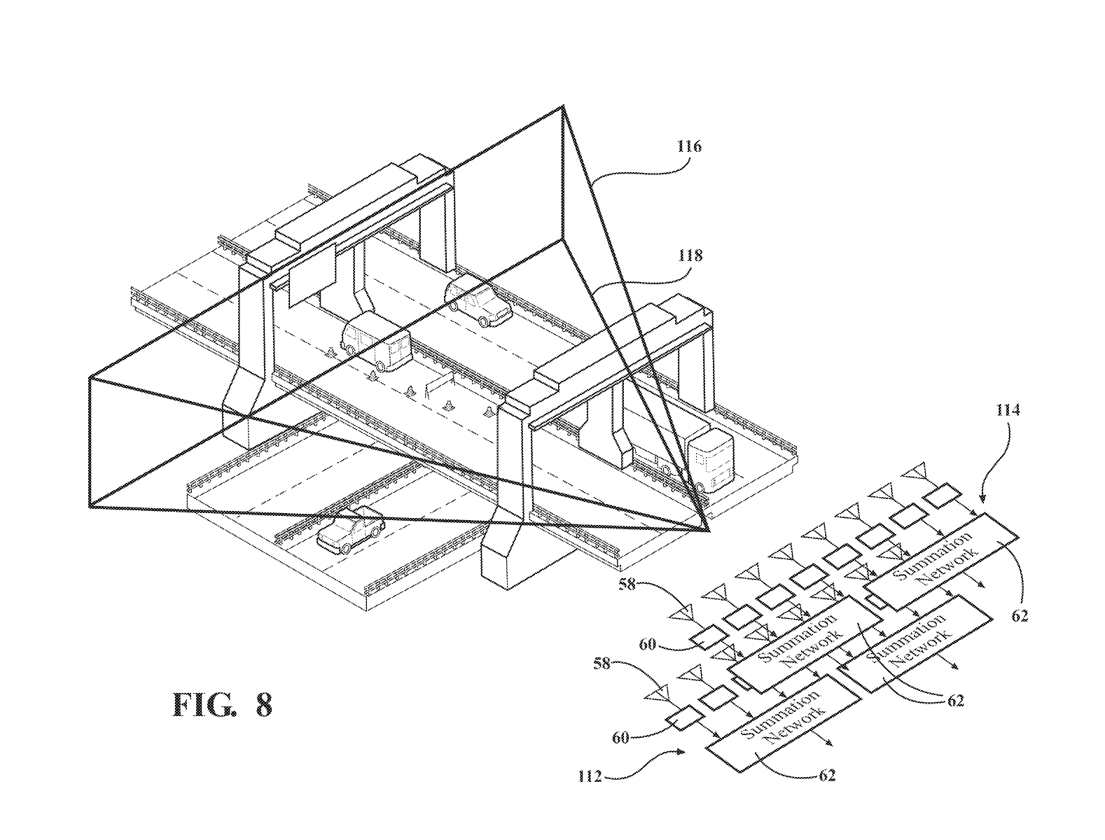

In FIG. 8, the same receiver sub-array 14 is arranged in two parallel arranged linear groups of sub-arrays, including a first lower sub-array group 112 and an upper sub-array group 114. This stacked arrangement of receiver sub-arrays 112 and 114 forms a three dimensional envelope for object detection having an upper planar detection plane 116 and a spaced lower detection plane 118. This provides higher resolution for the detected signal since the stacked receiver sub-arrays 112 and 114 provide a measure of vertical scanning or tilt.

What is claimed is:

1. A radar apparatus for a vehicle, comprising:
a transmitter antenna array in the form of an antenna array having multiple antenna elements;
a receiver antenna array in the form of at least one planar array antenna having multiple antenna elements, the receiver antenna array formed of a plurality of receiver sub-arrays, each receiver sub-array including a plurality of antenna elements, each having an antenna and a phase shifter, coupled to a summation network, a mixer and an A/D converter; and
the A/D converters coupled to a digital beamformer, the digital beamformer generating an output corresponding to a detected target, the output supplied as a tracking signal to the transmitter antenna array and the receiver antenna array.

2. The radar apparatus of claim 1 further comprising:
the digital beamformer providing steering control of the phase transmitter antenna array and the receiver antenna array using a data adaptive algorithm to minimize side lobe clutter.

3. The radar apparatus of claim 1 wherein the receiver antenna sub-arrays including the summation network and the mixer coupled to each summation, network, providing decision adaptive radar signal process.

4. The radar apparatus of claim 3 wherein:
the radar apparatus is a hybrid decision adaptive and data adaptive radar apparatus.

5. The radar apparatus of claim 1 wherein:
the transmitter antenna array is a single linear arranged antenna array.

6. The radar apparatus of claim 3 further comprising:
the digital beamformer and the data adaptive radar signal processing enabling simultaneous detection and tracking of multiple targets.

7. The radar apparatus of claim 1 further comprising:
the digital beamformer utilizing prestored weights of phase shift angles to generate a tracking signal for the transmitter antenna array and the receiver antenna array beam tracking in response to a detected target.

8. The radar apparatus of claim 1 further comprising:
the receiver antenna sub-arrays arranged in one of a single planar arrangement and a plurality of spaced stacked planar arrangements of receiver sub-arrays.

9. The radar apparatus of claim 9 wherein:
the plurality of spaced stacked planar arrangements of receiver sub-arrays providing a vertical field of view for target detection.

10. A radar apparatus for a vehicle, comprising:
a transmitter antenna array in the form of an antenna array having multiple antenna elements;
a receiver antenna array in the form of at least one planar array antenna having multiple antenna elements, the receiver antenna array formed of a plurality of receiver sub-arrays, each receiver sub-array including a plurality of antenna elements, each having an antenna and a phase shifter, coupled to a summation network, a mixer, and an A/D converter;
the A/D converters coupled to a digital beamformer, the digital beamformer generating an output corresponding to a detected target, the output supplied as a tracking signal to the transmitter antenna array and the receiver antenna array;
the digital beamformer providing steering control of the phase transmitter antenna array and the receiver array using a data adaptive algorithm to minimize side lobes in the target signal; and
the receiver antenna sub-arrays including the summation network and the mixer coupled to each summation network providing decision adaptive radar signal processing.

11. The radar apparatus of claim 10 further comprising:
the digital beamformer and the data adaptive radar signal processing enabling simultaneous detection and tracking of multiple targets.

12. The radar apparatus of claim 10 further comprising:
the digital beamformer utilizing prestored weights of phase shift angles to generate a tracking signal for the transmitter antenna array and the receiver antenna array beam tracking in response to a detected target.

13. The radar apparatus of claim 10 further comprising:
the receiver antenna sub-arrays arranged in one of a single planar arrangement and a plurality of spaced stacked planar arrangements of receiver sub-arrays.

14. The radar apparatus of claim 13 further comprising:
the plurality of spaced stacked planar arrangements of receiver sub-arrays providing a vertical field of view for target detection.
